(19) United States
(12) Patent Application Publication
(10) Pub. No.: US 2025/0338143 A1
(43) Pub. Date: Oct. 30, 2025

(54) NODE CLUSTERING BATCH DISTRIBUTION FOR A FIRMWARE SCHEDULER

(71) Applicant: Rakuten Symphony, Inc., Tokyo (JP)

(72) Inventor: Tasnim AHMED, Tokyo (JP)

(21) Appl. No.: 18/644,119

(22) Filed: Apr. 24, 2024

(51) Int. Cl. H04W 16/18; G06F 8/65

(52) U.S. Cl. CPC H04W 16/18; G06F 8/65

(57) ABSTRACT

An aspect of this description relates to a method including receiving a list of radio nodes usable in a wireless network. Each of the radio nodes has a corresponding coverage area. The method includes selecting a first radio node from the list of radio nodes. The method includes creating a first batch in which one or more radio nodes are to be assigned. The method includes assigning the first radio node to the first batch. The method includes selecting a second radio node. The method includes determining whether the corresponding coverage area of the second radio node overlaps with the corresponding coverage area of the first radio node. The method includes assigning the second radio node to the first batch in response to a determination that the corresponding coverage area of the second radio node does not overlap with the corresponding coverage area of the first radio node.

### TECHNICAL FIELD

This description relates to node clustering batch distribution for a firmware scheduler, and method of using the same.

### BACKGROUND

A radio access network (RAN) is part of a telecommunication system and implements radio access technology. RANs reside between a device, such as a mobile phone, a computer, or remotely controlled machine, and provides connection with a core network (CN). Depending on the standard, mobile phones and other wireless connected devices are varyingly known as user equipment (UE), terminal equipment (TE), mobile station (MS), and the like.

Centrally controlling networks has been shown to provide value to network operators. Firmware updates are often performed periodically or based on triggers. During a firmware update, a radio node is disconnected from a network. Therefore, bulk firmware updates that are performed by randomly selecting radio-nodes, e.g., Virtualized Central Units (VCUs) or Open CUs, for a given area results in catastrophic scenarios. Examples of such catastrophic scenarios include coverage blackout, a steep drop in hand-over success, or the like.

### SUMMARY

An aspect of this description relates to a method. The method includes receiving a list of radio nodes, wherein each of the radio nodes is usable in a wireless network, and each of the radio nodes has a corresponding coverage area. The method further includes selecting, by a processor, a first radio node from the list of radio nodes. The method further includes creating, by the processor, a first batch in which one or more radio nodes are to be assigned. The method further includes assigning, by the processor, the first radio node to the first batch. The method further includes selecting, by the processor, a second radio node from the list of radio nodes. The method further includes determining, by the processor, whether the corresponding coverage area of the second radio node overlaps with the corresponding coverage area of the first radio node. The method further includes assigning, by the processor, the second radio node to the first batch in response to a determination that the corresponding coverage area of the second radio node does not overlap with the corresponding coverage area of the first radio node.

An aspect of this description relates to an apparatus. The apparatus includes a processor configured to access computer-readable instructions. The processor is configured to execute the computer-readable instructions to cause the apparatus for receiving a list of radio nodes, wherein each of the radio nodes is usable in a wireless network, and each of the radio nodes has a corresponding coverage area. The processor is configured to execute the computer-readable instructions to cause the apparatus for selecting a first radio node from the list of radio nodes. The processor is configured to execute the computer-readable instructions to cause the apparatus for creating a first batch in which one or more radio nodes are to be assigned. The processor is configured to execute the computer-readable instructions to cause the apparatus for assigning the first radio node to the first batch. The processor is configured to execute the computer-readable instructions to cause the apparatus for selecting a second radio node from the list of radio nodes. The processor is configured to execute the computer-readable instructions to cause the apparatus for determining whether the corresponding coverage area of the second radio node overlaps with the corresponding coverage area of the first radio node. The processor is configured to execute the computer-readable instructions to cause the apparatus for assigning the second radio node to the first batch in response to a determination that the corresponding coverage area of the second radio node does not overlap with the corresponding coverage area of the first radio node.

An aspect of this description relates to a non-transitory computer-readable media having computer-readable instructions stored thereon. The computer-readable instructions when executed by a processor causes an apparatus to receive a list of radio nodes, wherein each of the radio nodes is usable in a wireless network, and each of the radio nodes has a corresponding coverage area. The computer-readable instructions when executed by a processor causes an apparatus to select a first radio node from the list of radio nodes. The computer-readable instructions when executed by a processor causes an apparatus to create a first batch in which one or more radio nodes are to be assigned. The computer-readable instructions when executed by a processor causes an apparatus to assign the first radio node to the first batch. The computer-readable instructions when executed by a processor causes an apparatus to select a second radio node from the list of radio nodes. The computer-readable instructions when executed by a processor causes an apparatus to determine whether the corresponding coverage area of the second radio node overlaps with the corresponding coverage area of the first radio node. The computer-readable instructions when executed by a processor causes an apparatus to assign the second radio node to the first batch in response to a determination that the corresponding coverage area of the second radio node does not overlap with the corresponding coverage area of the first radio node.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a pictorial diagram of a mobile network in accordance with some embodiments;

FIG. 2 is a block diagram of an Open Radio Access Network (O-RAN) according to some embodiments;

FIG. 3 is a flowchart of a method for node batch distribution according to some embodiments;

FIG. 4 is a high-level functional block diagram of a processor-based system according to at some embodiments.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming, or signaling-streaming. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB), “home access point (HAP),” “node”, or the like refer to a wireless network component or apparatus that serves and receives data, control, voice, video, sound, gaming, data-streaming or signaling-streaming from UE.

A smart scheduler prepares for automatic bulk/batchwise radio-node software/firmware updates and other maintenance activities. The scheduler is able to provide advantages including reducing the impact on network coverage area by, for example, utilizing the neighboring nodes, maintaining handover success rates among radio-nodes, e.g., handover success rates close to a pre-schedule period, minimizing a reduction of internet protocol (IP) network traffic by shutting down nodes at the optimal time when the throughput is a minimum, updating nodes while the least number of users are connected, and ensuring adequate coverage and handover support for the high priority nodes, e.g., nodes that very-important peoples (VIP's) or many subscribers are connected.

A smart scheduler provides automatic bulk/batchwise scheduling of software upgrade for radio nodes. During software updates or maintenance activity for the radio nodes (e.g., those nodes scheduled for an update or maintenance activity) inside a coverage area, e.g., 1000 VCUs, O-CUs, or other telecom devices inside an area. Field engineers manually shut down one or two devices inside a small area and do not switch off the other nodes close to the shutdown devices so that there is no significant impact on the consumers, e.g., no coverage blackout inside that area.

Currently there is no automatic system that resolves the issues that call for consideration. For example, the issues to be taken into consideration include knowing the coverage area that is affected in response to a network operator shutting down a node. Other issues include knowing what percentage of the coverage area is not available, whether handovers to a nearby node are able to continue, is the IP traffic for the affected area or the uplink and downlink data traffic of the area able to be handled by the current remaining nodes inside that area, are devices close to the affected nodes not able to be handed over to other nodes, what are the number of nodes affected, and what is the portion of the area that is affected.

The smart scheduler takes these issues into consideration automatically and attempts to make a schedule of automatic software updates that are to be executed at one time. At any instance, there is always a balance. While affecting some consumers is acceptable, large-scale impact to consumers is to be avoided. The smart scheduler is to keep the impact to the system and to customers significantly low or manageable. Node network coverage area affected is minimized and the handover success rate among the radio nodes is maintained, the reduction of IP network traffic is minimized by updating nodes while the least number of users are connected. A timeslot during the day is to be selected where the least number of users are connected, and adequate coverage is ensured. Handover support for high priority nodes is further ensured. For example, in response to the updated node involving a crowed public place or there are VIPs at the location, e.g., hotspots. More emphasis is to be given to those points.

The smart scheduler includes a first layer for monitoring applications such as radio nodes, e.g., node coverage monitors and radio node status monitors. Information is collected from the coverage monitor, such as the coverage information and handover information. The status monitor provides connected subscriber count and traffic statistics.

Collected node data and clustering parameters are used to perform node clustering operations. The clustering operation handles the clustering of the radio nodes in a particular area in a way that each batch is to be shut down at once without significant impact, such as causing a coverage area blackout or other service issue. The safest nodes that are to be shutdown are identified and clustered together.

The node clustering operations involve batch recommendation module that determines a best neighbor of each node for compensation based on coverage, handover, and hotspots. Neighbor sequencing is performed to prioritize gain in collective coverage. The smart scheduler is configured to use artificial intelligence (AI) to reduce the impact on network coverage, hand-over success, IP network traffic, and connected subscribers. For example, AI is used for sequencing neighbor nodes for choosing the best neighbor as a compensator node. In response to one node shutting down, compensating neighbor nodes that are close and the most capable of minimizing that shutdown are identified. AI ranks the neighbors in terms of their compensating capacity. The clustering operation performs agglomerative hierarchical clustering based on an unsupervised machine learning (ML) module to select compensating neighboring nodes for compensating for source nodes during the firmware upgrade of the source nodes to provide maximum coverage and handover.

The neighbor sequencing receives a node list, identifies neighbor nodes to each node that is to be updated, and sequences or sorts neighbor nodes according to a combined coverage capacity. Net collective coverage ratio, average handover success rate, and total handover attempt ratio are determined. Estimates for determining collective neighbor compensation is performed using the net collective coverage ratio, average handover success rate, and total handover attempt ratio. The collective neighbor compensation is based on weighted average of the net collective coverage ratio, average handover success rate, and total handover attempt ratio, wherein the collective coverage ratio is weighted at 70%, the average handover success rate is weighted at 20%, and the handover attempt ratio is weighted at 10%. A compensation risk is determined based on the collective neighbor compensation. Batch distribution is performed to identify a batch of source nodes for updating the firmware based on the compensation risk.

A scheduling operation determines a schedule for upgrading radio node clusters that provide a minimal impact on data traffic and connected subscribers. The smart scheduler performs a scheduling operation using AI to calculate a scheduling duration by forecasting traffic and a sub count for source nodes based on historical time series data. The smart scheduler prioritizes the traffic and subscriber count for individual clusters, so the scheduler assigns the best timeslot to that cluster. The smart scheduler determines a timeslot for each batch. The smart scheduler performs risk assessment to minimize scheduling risk and determines how efficiently the smart scheduler performs an update based on performance metrics. In the scheduling operations, timeslots for each batch are ranked based on the forecast traffic volume and subscriber count for the source nodes in the batch. A highest priority batch is selected based on the hotspot count. Timeslots that are compatible for the batch are identified based on a batch schedule criterion. A highest priority compatible timeslot having a least number of allocated batches is selected. Then, the selected highest priority compatible timeslot is assigned to the highest priority batch. Hotspots are prioritized to determine a scheduled timeslot having a lowest traffic and to provide additional coverage for the prioritized source nodes.

After completion of the scheduling operation, clustering output is produced by the clustering operation, scheduling output is produced by the scheduling operation, and map visualization is produced by the clustering output and the scheduling operation. Geo analytics is used to provide maximum collective coverage. The geographic map is checked for a radio node coverage area to determine the collective coverage capacity of multiple nodes to compensate for a particular node. The geographic map provides performance statistics and map visualization associated with node device performance, batchwise performance, and overall performance.

In some embodiments, a batch distribution algorithm for the smart scheduler is discussed. In some embodiments, a batch distribution algorithm in a node clustering operation for the smart scheduler is discussed.

In some embodiments, a set of criteria is satisfied before source radio nodes are grouped into a batch. In some embodiments, a source node is a radio node that has been selected, from the list of radio nodes, to be placed into a batch where the batch of radio nodes are to be firmware updated together. In some embodiments, a neighbor node or compensator node is a radio node that is potentially compensating for radio coverage area of the source nodes down for firmware updating.

One criterion is no direct interference between the source nodes (e.g., coverage area for the source nodes do not overlap). Thus, the source nodes in a batch are not direct neighbors. The source nodes in the batch shut down/upgraded together and the neighbor nodes function as compensators for the down or upgrading source node. Another criterion includes a source node and corresponding neighbor nodes for the source node are unable to be shut down together.

In some embodiments, batch criteria ensure a source node and neighboring node are not shut down together. The batch criteria include: (1) a source is unable to be in multiple batches; (2) one node is unable to be usable as both source and neighbor (to other source nodes) within the same batch (and therefore at the same time); and (3) a neighbor node compensates for a user-defined number of source nodes (based on a compensator repetition user input discussed in detail below). This is a precautionary measure preventing a neighbor from being overwhelmed by compensating for too many source nodes.

In some embodiments, a user inputs a compensator repetition count, which is the maximum number of source nodes a neighbor supports simultaneously. For example, in response to trying to shut down two source nodes at the same time and one compensator node to compensate for both source nodes, the compensatory repetition count determines whether this scenario occurs. In response to the compensator repetition count being two, then this scenario is accepted as satisfying the third criteria. In response to the compensator repetition count being one, then this scenario is rejected as not satisfying the third criteria.

In some embodiments, a user inputs a compensator repeat priority, which is the impact ratio of compensator repetition in the overall compensation risk score. A compensator that is used for compensating for multiple source nodes at the same time raises a risk of an overload with handovers. Compensator repeat priority sets a priority limit to use while calculating the compensation risk.

In some embodiments, a user selects uniform batch distribution at a user interface, which is used to ensure near uniform distribution of radio nodes across the batches. With a uniform batch distribution, an equal to near equal number of nodes are included in each batch. In some embodiments, the batch distribution algorithm ensures uniform distribution of nodes across batches. The batch criteria ensures that proper batch-distribution is being fulfilled. In response to shutting down uniform batch distribution, one batch is able to have more nodes than another batch and the performance of every batch is not the same.

In some embodiments, in response to a user being unsatisfied with a simulation performance of a first batch count (e.g., total number of batches), the user is able to choose another batch count to either increase or decrease the batch count.

In some embodiments, after a batch distribution operation, the recommended number of primary batches (i.e., system-recommended batches after the batch-distribution operation) are presented. However, a batch number (batch count) is able to be changed by the user. In some embodiments, in response to a user increasing the batch number, primary batches are sliced in half until the target number of secondary batches (based on user input for batch count) is reached. In some embodiments, smaller batches, which result in larger batch counts, ensure more reliable scheduling operations. Nevertheless, reducing the number of batches risks failing the third condition of the batch criteria. That is, reducing the number of batches increases the neighbor repeat ratio and therefore, increases the risk of a neighbor being overwhelmed by compensating for too many source nodes.

In a non-limiting example, a batch distribution algorithm begins by selecting a source radio node from a list of nodes (e.g., a list of nodes with software updates pending). The algorithm proceeds by creating a new batch and then assigns the source node to the new batch. The algorithm then determines whether there are any remaining nodes. In response to there being no remaining nodes, the algorithm terminates, and the batch distribution is complete. In response to there being nodes remaining, the algorithm proceeds to select the next node. In the next operation, the algorithm determines whether a smallest created batch is compatible with the next node based on the batch criteria.

In response to the smallest batch being compatible, the algorithm returns to a prior operation and assigns the next node to that batch. In response to the node not being compatible with the smallest batch, the algorithm proceeds to determine whether there are any other remaining batches. In response to there being no other remaining batches, the algorithm returns to a prior operation and creates a new batch for the new node. In response to there being remaining batches, the algorithm returns to a prior operation and determines whether the smallest batch, of the remaining batches, is compatible with the next node and the iterative process continues until a compatible batch is found or a compatible batch is not found and a new batch is created. Batch distribution is performed to identify a batch of source nodes for updating the firmware based on the compensation risk.

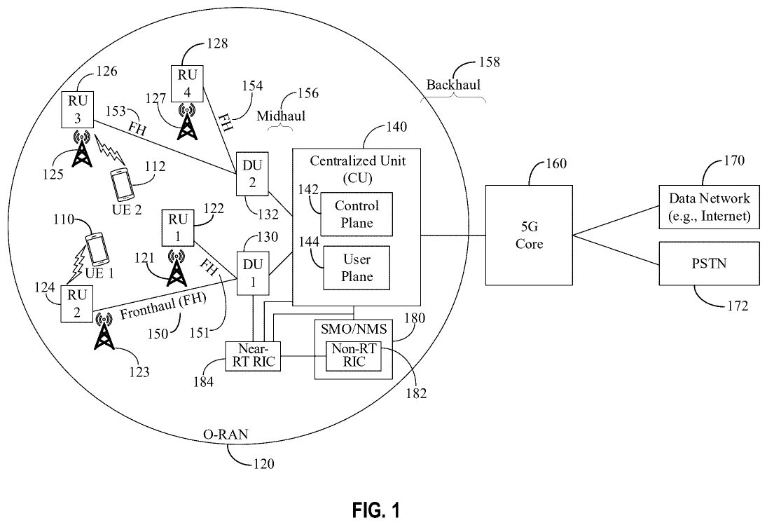

FIG. 1 illustrates a mobile network 100 in accordance with some embodiments.

In FIG. 1, UE 1 (User Equipment 1) 110 and UE 2 112 access Mobile Network 100 via a Radio Access Network (RAN) 120.

RAN 120 includes Radio Towers 121, 123, 125, and 127. Radio Towers 121, 123, 125, 127 are associated with RU (Radio Unit) 1 122, RU 2 124, RU 3 126, and RU 4 128, respectively.

RU 1 122, RU 2 124, RU 3 126, RU 4 128 handle the Digital Front End (DFE) and the parts of the PHY layer, as well as the digital beamforming functionality. RU 1 122 and RU 2 124 are associated with Distributed Unit (DU) 1 130, and RU 3 126 and RU 4 128 are associated with DU 2 132. DU 1 130 and DU 2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data moves across the physical network.

DU 1 130 is coupled to the RU 1 122 and RU 2 124, and DU 2 132 is coupled to RU 3 126 and RU 4 128. DU 1 130 and DU 2 132 run the RLC, MAC, and parts of the PHY layer. DU 1 130 and DU 2 132 include a subset of the eNB/gNB functions, depending on the functional split option, and operation of DU 1 130 and DU 2 132 are controlled by Centralized Unit (CU) 140. CU 140 is responsible for non-real time, higher L2 and L3. Server and relevant software for CU 140 is hosted at a site or is hosted in an edge cloud (datacenter or central office) depending on transport availability and the interface for the Fronthaul connections 150, 151, 153, 154. The server and relevant software of CU 140 is further co-located at DU 1 130 or DU 2 132 or is hosted in a regional cloud data center.

CU 140 handles the RRC and PDCP layers. The gNB includes CU 140 and one or more DUs, e.g., DU 1 130, connected to CU 140 via Fs-C and Fs-U interfaces for a Control Plane (CP) 142 and User Plane (UP) 144, respectively. CU 140 with multiple DUs, e.g., DU 1 130, and DU 2 132, support multiple gNBs. The split architecture enables a 5G network to utilize different distribution of protocol stacks between CU 140, and DU 1 130 and DU 2 132, depending on network design and availability of the Midhaul 156. While two connections are shown between CU 140 and DU 1 130 and DU 2 132, CU 140 implements additional connections to other DUs. CU 150, in 5G, implements, for example, 256 endpoints or DUs. CU 140 supports the gNB functions such as transfer of user data, mobility control, RAN sharing (MORAN), positioning, session management, and the like. However, one or more functions are allocated to the DU. CU 140 controls the operation of DU 130 and DU 132 over the Midhaul interface 156.

Backhaul 158 connects the 4G/5G Core 160 to the CU 140. In some embodiments, core 160 is, for example, up to 200 km away from the CU 140. Core 160 provides access to voice and data networks, such as Internet 170 and Public Switched Telephone Network (PSTN) 172.

In some embodiments, RAN 120 implements beamforming that allows for directional transmission or reception. 5G beamforming enables 5G connections to be more focused toward a receiving device. RAN 120 is further able to implement MIMO (Multiple Input Multiple Output), including mMIMO (massive MIMO), to provide an increase in throughput and signal-to-noise ratio (SNR). MIMO improves the radio link by using the multiple paths over which signals travel from the transmitter to the receiver. The multiple paths are de-correlated and this provides the opportunity to send multiple data streams over them.

Massive MIMO and dense small cell deployments are being implemented to improve radio resource efficiency. However, the intra-cell interference from neighboring cells presents a serious problem. According to some embodiments, the modeling of interference patterns in a Massive MIMO deployment is used to identify interfering beams between different sectors so that interference optimization techniques are able to be applied to address interference.

According to some embodiments, a northbound platform for the network is provided, such as a Service Management and Orchestration (SMO)/NMS 180. SMO 180 oversees the orchestration aspects, and the management and automation of RAN elements. SMO 180 supports O1, A1 and O2 interfaces. Non-RT RIC (non-Real-Time RAN Intelligent Controller) 182 enables non-real-time control and optimization of RAN elements and resources, AI/ML workflow including model training and updates, and policy-based guidance of applications/features in Near-RT RIC 184. Near-RT RIC 184 enables near-real-time control and optimization of O-RAN elements and resources via fine-grained data collection and actions over the E2 interface. Near-RT RIC 184 includes interpretation and enforcement of policies from Non-RT RIC 182, and supports enrichment information to optimize control function.

Near-RT RIC 184 obtains information associated with the beams that is passed to Non-RT RIC 182 and processed, for example, by an rApp at the Non-RT RIC 184, to generate an interference matrix. xApps are hosted on the Near-RT RIC 184 and are useable to optimize radio spectrum efficiency. rApps are specialized microservices operating on the Non-RT RIC 211. xApps and rApps provide control and management features and functionality.

AI-Based Network Management is able to be provided at the 5G Edge via the rApps in the Non-RT RIC 182. Data is collected by a Node, such as an O-CU 140. Collected Data is processed. The ML Model at the Non-RT RIC 182 is Trained/Optimized using the processed data from the database. By implementing AI-Based Network Management at the 5G EDGE, performance is adjusted through continuous learning, and failures are handled by model monitoring. Uses cases include one or more of anomaly detection, traffic classification, network slicing, mitigation of interference between beams or antennas, or between neighboring cell sites, control of electromagnetic emissions, prediction of user and traffic distribution patterns, derivation of the optimal configuration of massive MIMO parameters of cells or beams, maximization of RAN sharing, maintenance of efficient operation through performance diagnostics, assurance of end-to-end Service Level Agreements (SLAs), and the like.

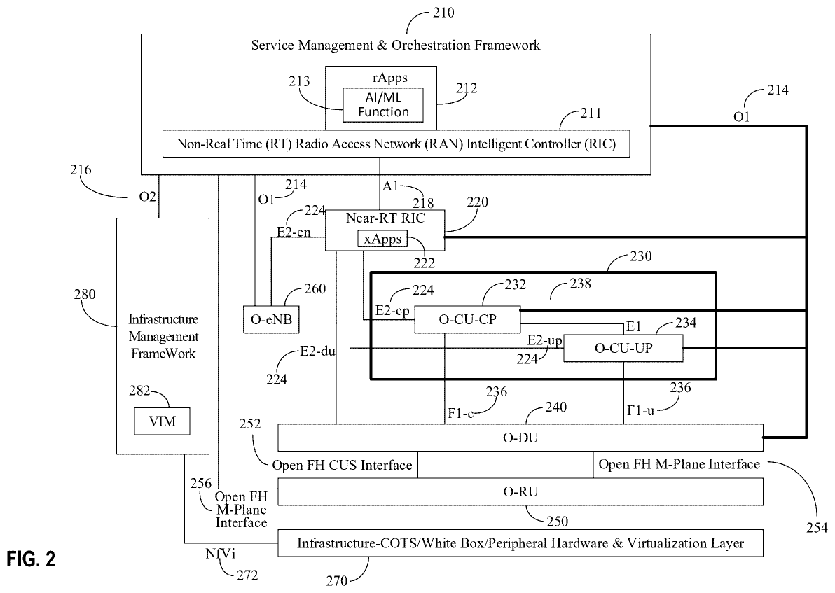

FIG. 2 is a block diagram of an Open Radio Access Network (O-RAN) 200 according to some embodiments.

In FIG. 2, Service Management and Orchestration (SMO) Framework 210 is an automation platform for Open RAN Radio Resources. SMO 210 oversees lifecycle management of network functions as well as O-Cloud. SMO 210 includes a Non-Real-Time (RT) Radio Access Network (RAN) Intelligent Controller (RIC) 211. SMO 210 further defines various SMO interfaces, such as the O1 214, O2 216, and A1 218 interfaces.

The A1 interface 218 enables communication between the Non-RT RIC 211 and a Near-RT RIC 220 and supports policy management, data transfer, and machine learning management. The A1 interface 218 is further used for policy guidance. SMO 210 provides fine-grained policy guidance such as getting User-Equipment to change frequency, and other data enrichments to RAN functions over the A1 interface 218.

The O1 214 interface connects the SMO 210 to the RAN managed elements, which include the Near-RT RIC 220, O-RAN Centralized Unit (O-CU) 230, O-RAN Distributed Unit (O-DU) 240, and the Open Evolved NodeB (O-eNB) 260. The management and orchestration functions are received by the managed elements via the O1 interface 214. The SMO 210 in turn receives data from the managed elements via the O1 interface 214 for AI model training at the Non-RT RIC 211. The O1 interface 214 is further used for managing the operation and maintenance (OAM) of multi-vendor Open RAN functions including fault, configuration, accounting, performance and security management, software management, and file management capabilities.

The O2 interface 216 is used to support cloud infrastructure management and deployment operations with O-Cloud infrastructure that hosts the Open RAN functions in the network. The O2 interface 216 supports orchestration of O-Cloud infrastructure resource management (e.g., inventory, monitoring, provisioning, software management and lifecycle management) and deployment of the Open RAN network functions, providing logical services for managing the lifecycle of deployments that use cloud resources.

SMO 210 provides a common data collection platform for management of RAN data as well as mediation for the O1 214, O2 216, and A1 218 interfaces. Licensing, access control and AI/ML lifecycle management are supported by the SMO 210, together with legacy north-bound interfaces. SMO 210 further supports existing OSS functions, such as service orchestration, inventory, topology, and policy control.

The Non-RT RIC 211 enables non-real-time (>1 second) control of RAN elements and their resources through cloud-native microservice-based applications, which are referred to as rApps 212. An rApp 212 implements an AI/ML Function 213. Non-RT RIC 211 communicates with applications called xApps 222 running on a Near-RT RIC 211 to provide policy-based guidance for edge control of RAN elements and their resources. The Non-RT RIC 211 provides non-real-time control and optimization of RAN elements and resources, AI/ML workflow, including model training of the AI/ML Function 213, updates, and policy-based guidance of applications/features in Near-RT RIC 220.

Near-RT RIC 220 controls RAN infrastructure at the cloud edge. Near-RT RIC 220 controls RAN elements and resources with optimization actions that typically take 10 milliseconds to one second to complete. The Near-RT RIC 220 receives policy guidance from the Non-RT RIC 211 and provides policy feedback to the Non-RT RIC 211 through the xApps 222.

The xApps 222 are used to enhance the RAN's spectrum efficiency. The Near-RT RIC 220 manages a distributed collection of “southbound” RAN functions, and further provides “northbound” interfaces for operators: the O1 214 and A1 218 interfaces to the non-RT RIC 211 for the management and optimization of the RAN. The Near-RT RIC 220 is thus able to self-optimize across different RAN types, like macros, Massive MIMO, and small cells, maximizing network resource utilization for 5G network scaling.

Within the Near-RT RIC 220, the xApps 222 communicate via defined interface channels. An internal messaging infrastructure provides the framework to handle conflict mitigation, subscription management, app lifecycle management functions, and security. Data transfers are implemented via the E2 interface.

The O-RAN is split into a Central Unit (CU) 230, a Distributed Unit (DU) 240, and a Radio Unit (RU) 250. The CU 230 is further split into two logical components, one for the Control Plane (CP) 232, and one for the User Plane (UP) 234. The logical split of the CU 230 into the CP 232 and UP 234 allows different functionalities to be deployed at different locations of the network, as well as on different hardware platforms. For example, CUs 230 and DUs 240 can be virtualized on white box servers at the edge, while the RUs 250 are implemented on Field Programmable Gate Arrays (FPGAs) and Application-specific Integrated Circuits (ASICs) boards and deployed close to RF antennas.

The O-RAN Distributed Unit (O-DU) 240 is an edge server that includes baseband processing and radio frequency (RF) functions. The O-DU 240 hosts radio link control (RLC), MAC, and a physical layer with network function virtualization or containers. O-DU 240 supports one or more cells, and the O-DUs are able to support one or more beams to provide the operating support for O-RU 250 by CUS (Control, User, and Synchronization) planes 252, and management (M) planes 254 through front-haul interfaces.

The O-RU 250 processes radio frequencies received by the physical layer of the network. The processed radio frequencies are sent to the O-DU 240 through fronthaul interfaces 252, 254. The O-RU 250 hosts the lower PHY Layer Baseband Processing and RF Front End (RF FE) and is designed to support multiple 3GPP split options.

An Open-Evolved Node B (O-cNB) 260 provides the hardware aspect of the O-RAN. The management and orchestration functions are received by the managed elements via the O1 interface 214. The SMO 210 in turn receives data from the managed elements via the O1 interface 214 for AI model training of AI/ML Functions 213 implemented by rApps 213 at non-RT RIC 211. The O-eNB 260 communicates with the Near-RT RIC 220 via the E2 interface 224. E2 224 enables near-real-time loops through the streaming of telemetry from the RAN and the feedback with control from the Near-RT RIC 220. The E2 interface 224 connects the Near-RT RIC 220 with an E2 node, such as the O-CU-CP 232, O-CU-UP 234, the O-DU 240, and the O-eNB 260. An E2 node is connected to one Near-RT RIC 220, while a Near-RT RIC is connected to multiple E2 nodes. The protocols over the E2 interface 224 are based on the control plane and supports services and functions of Near-RT RIC 220.

An F1 Interface 236 connects the O-CU-CP 232 and the O-CU-UP 234 to the O-DU 240. Thus, the F1 interface 236 is broken into control and user plane subtypes and exchanges data about the frequency resource sharing and other network statuses. One O-CU 230 can communicate with multiple O-DUs 240 via F1 interfaces 236.

An E1 238 interface connects the O-CU-CP 232 and the O-CU-UP 234. The E1 Interface 238 is used to transfer configuration data and capacity information between the O-CU-CP 232 and the O-CU-UP 234. The configuration data ensures the O-CU-CP 232 and the O-CU-UP 234 interoperate. The capacity information is sent from the O-CU-UP 234 to the O-CU-CP 232 and includes the status of the O-CU-UP 234.

The O-DU 240 communicates with the O-RU 250 via an Open Fronthaul (FH) Control, User, and Synchronization (CUS) Plane Interface 252 and an M-Plane (Management Plane) Interface 254. As part of the CUS Plane Interface 252, the C-Plane (control plane) is a frame format that carries data in real-time control messages between the O-DU 240 and O-RU 250 for use to control user data scheduling, beamforming weight selection, numerology selection, etc. Control messages are sent separately for downlink (DL)-related commands and uplink (UL)-related commands.

The U-Plane carries the user data messages between the O-DU 240 and O-RU 250, such as the in-phase and quadrature-phase (IQ) sample sequence of the orthogonal frequency division multiplexing (OFDM) signal. The S-plane includes synchronization messages used for timing synchronization between O-DU 240 and O-RU 250. The Control and User Plane are further useable to send information specifying beamforming weights from the O-DU 240 to O-RU 250. Other information includes time resource and frequency resource information.

The M-Plane 254 connects the O-RU 250 to the O-DU 240, and an optional M-Plane 256 connects the O-RU 250 to the SMO 210. The O-DU 240 uses the M-Plane 254 to manage the O-RU 250, while the SMO 210 provides FCAPS (Fault, Configuration, Accounting, Performance, Security) services to the O-RU 250. The M-plane 254 supports the management features including startup installation, software management, configuration management, performance management, fault management and file management.

The M-Plane 254 is used by the O-DU 240 to retrieve the capabilities of the O-RU 250 and to send relevant configuration related to the C-Plane and U-Plane (data plane) to the O-RU 250. Together the O1 214 and Open-Fronthaul M-plane 254 interfaces provide a FCAPS interface with configuration, reconfiguration, registration, security, performance, monitoring aspects exchange with individual nodes, such as O-CU-CP 232, O-CU-UP 234, O-DU 240, and O-RU 250, as well as non-RT RIC 220.

Infrastructure-COTS/White Box/Peripheral Hardware & Virtualization Layer 270 connects to Infrastructure Management Framework 280 via Network Function Virtualization Interface (NFVI) 272. Virtualized Infrastructure Manager (VIM) 282 at Infrastructure Management Framework 280 controls and manages virtual network functions.

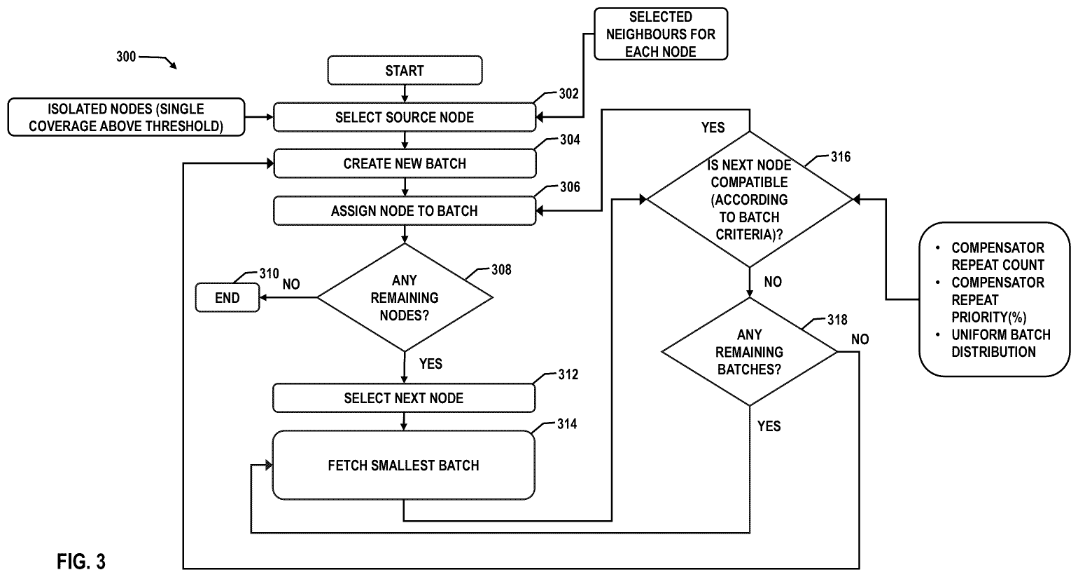

FIG. 3 is a flowchart 300 of a method for node batch distribution (NBD) according to some embodiments.

In some embodiments, NBD method 300 describes process tasks for node batch distribution in a node clustering operation as part of a smart scheduler architecture. While the operations of NBD method 300 are discussed and shown as having a particular order, each operation in NBD method 300 is configured to be performed in any order unless specifically called out otherwise. NBD method 300 is implemented as a set of operations, such as operations 302 through 318.

In some embodiments, NBD method 300 is a batch distribution operation for the smart scheduler. In some embodiments, NBD method 300 is configured with a set of criteria that determine a group of source nodes which satisfy certain criteria to be considered as a batch. In some embodiments, a batch is a group of nodes that do not directly interfere with each. That means the nodes in a batch are not direct neighbors, and therefore capable of being shut down together. Neighbor nodes are compensator nodes to the source node in response to the source node being shut down. Therefore, a source node and the compensating neighbor node are not shut down together.

In some embodiments, a source node satisfies several criteria before being added to a preexisting batch containing one or more source nodes. One criterion stipulates that a source node is unable to be in multiple batches. Another criterion is a source node is unable to be configured as both a source node and a neighbor node in the same batch. Yet another criterion is a neighbor node is unable to exceed a user-defined compensator repeat count (e.g., a user-defined number of sources). This criterion is a precaution to prevent neighbor nodes from being overwhelmed by compensating for too many source nodes. In response to these criteria being satisfied, a source node is added to a pre-existing batch.

In some embodiments, the batch distribution algorithm ensures uniform or near-uniform distribution of the source nodes across batches. In some embodiments, the batch criteria ensure a near uniform or uniform distribution is being fulfilled. As discussed below, the batch distribution algorithm attempts to pair source nodes with the smallest existing batch to ensure as uniform a distribution as possible.

At operation 302 of MBD method 300, the batch distribution algorithm selects a node (to be a source node) from a list of nodes provided by the smart scheduler. In some embodiments, a list of nodes is provided by a batch recommendation module (not discussed herein), that filters a nodes master list into isolated nodes, which have single coverage (e.g., percentage of the coverage area for a node that is not shared/covered by any other neighbor node) above a threshold (e.g., minimum single coverage for a radio node to consider isolated), and filtered nodes, which have single coverage below threshold.

In some embodiments, the single coverage threshold is a user-determined threshold set in a user interface (not discussed herein). In a non-limiting example, in response to a user setting the single coverage threshold at 80%, the batch recommendation module separates nodes having a single coverage threshold at 80% or worse and places the nodes in an isolated nodes grouping.

Continuing with the non-limiting example, the batch recommendation module filters nodes from the master node list having a single coverage threshold lower than 80% and places the nodes in a filtered nodes grouping, which is later processed for neighbor sequencing and compensating. The isolated nodes are not considered for neighbor sequencing and compensating as these nodes are isolated at or beyond a user-defined threshold, which the user believes makes the nodes unusable as a compensating neighbor node. The filtered nodes are eventually sent to the batch distribution algorithm as selected neighbor nodes for each node. These neighbor nodes are used in the criteria determination discussed below in operation 316. Both the isolated nodes and filtered nodes are also used in operation 302 as each node in the master node list is scheduled to have the firmware updated. Process flows from operation 302 to operation 304.

At operation 304 of MBD method 300, a new batch is created. Process flows from operation 304 to operation 306.

At operation 306 of MBD method 300, the node selected in operation 302 is assigned to the batch created in operation 304. Process flows from operation 306 to operation 308.

At operation 308 of MBD method 300, a determination is made by the batch distribution algorithm whether there are any remaining nodes which are unassigned to a batch. In response to no remaining nodes (“NO” branch of block 308), process flows to operation 310 where the batch distribution algorithm terminates, and the created batches are forwarded to a batch scheduling module (not discussed) to schedule timeslots to perform software/firmware updates. In response to nodes remaining (“YES” branch of block 308), process flows to operation 312.

At operation 312 of MBD method 300, another node is selected by the batch distribution algorithm. Process flows from operation 312 to operation 314.

At operation 314 of MBD method 300, the smallest existing batch at the time of execution of operation 314 is retrieved for a comparison with the selected node of operation 312. Process flows from operation 314 to operation 316.

At operation 316 of MBD method 300, a determination is made by the batch distribution algorithm whether the node selected at operation 312 is compatible with the smallest existing batch based upon the batch criteria. Therefore, the batch distribution algorithm determines, does the node already exist in the batch, is the node unusable as the node serves as a neighbor node for a source node in the batch, and, based on the compensator repetition count, is the node safe from causing a violation of the compensator repetition count (e.g., neighbor nodes are able to compensate without violating the user-defined compensator repeat count). This is a precautionary measure to prevent a neighbor being overwhelmed by interacting with too many sources.

In response to each criterion being satisfied (“YES” branch of block 316), process flows from operation 316 to operation 306 and the node of operation 312 is assigned to the smallest batch and the process continues iteratively again onto operation 308 as discussed above.

In response to at least one criterion not being satisfied (“NO” branch of block 316), process flows from operation 316 to operation 318.

At operation 318 of MBD method 300, the batch distribution algorithm determines whether there are any remaining existing batches in which to pair the node of operation 312. In response to there being no remaining batches to pair with (“NO” branch of block 318), process flows to operation 304, a new batch is created, and process flows to operation 306 as discussed above. In response to there being remaining batches to pair with (“YES” branch of block 318), process flows to operation 314, the smallest batch of the remaining batches is fetched, and process flows to operation 316 as discussed above.

In some embodiments, the iterative process of the batch distribution algorithm continues until the process reaches operation 310, all nodes are assigned to a batch, the batch distribution algorithm is complete, and the batches are outputted to a batch scheduling module.

In some embodiments, the user modifies the number of batches created. In some embodiments, the user increases or decreases the batch number. In some embodiments, the initial batch number is pre-determined by the batch distribution algorithm (e.g., based on number of nodes). In response to the user increasing the batch size, the primary batches (system-recommended batches after the batch-distribution operation) are sliced into halves (secondary batches) until the user-defined increased batch number equals the total number of primary and secondary batches.

In response to the user increasing the batch size, the batch distribution algorithm is repeated with the new user-defined decrease batch number. In some embodiments, smaller batches ensure more reliable scheduling. In some embodiments, based on a simulation of the batch distribution, the user increases the number of batches, which might be helpful for a smoother or reduced scheduling risk. In some embodiments, in response to the user wanting to reduce the number of batches, there is a possibility that the third criterion is violated. For example, a reduced number of batches increases a neighbor repeat ratio (e.g., smaller batches increase the number of source nodes in a batch, which increases the possibility of a neighbor node compensating for multiple source nodes and possibly violating the compensator repeat count). This has the potential to increase the risk of a neighbor node being overwhelmed due to interacting with too many source nodes. In an extreme non-limiting example, in response to a user decreasing the batch count to 1, then all the nodes are sources with no neighboring nodes to compensate. Thus, the compensation rate is 0% and the compensation risk score during a firmware update is 100% (meaning an assurance of no coverage during the update). Therefore, a user considers these risks in reducing the number of batches.

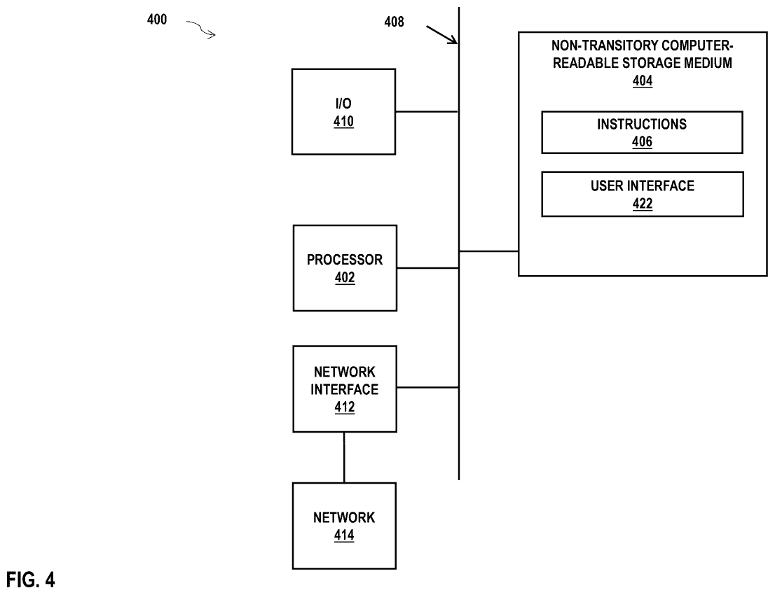

FIG. 4 is a high-level functional block diagram of a processor-based system 400 according to some embodiments.

In some embodiments, processor-based system 400 is a general-purpose computing device including a hardware processor 402 and a non-transitory, computer-readable storage medium 404. Storage medium 404, amongst other things, is encoded with, i.e., stores, computer program code 406, i.e., a set of executable instructions such as an algorithm, or method 300. Execution of instructions 406 by hardware processor 402 represents (at least in part) a batch distribution algorithm which implements a portion, or all the methods described herein in accordance with one or more embodiments (hereinafter, the noted processes and/or methods).

Processor 402 is electrically coupled to the computer-readable storage medium 404 via a bus 408. Processor 402 is further electrically coupled to an I/O interface 410 by bus 408. A network interface 412 is further electrically connected to processor 402 via bus 408. Network interface 412 is connected to a network 414, so that processor 402 and computer-readable storage medium 404 connect to external elements via network 414. Processor 402 is configured to execute computer program code 406 encoded in computer-readable storage medium 404 to cause processor-based system 400 to be usable for performing a portion or all the noted processes and/or methods. In one or more embodiments, processor 402 is a central processing unit (CPU), a multi-processor, a distributed processing system, an application specific integrated circuit (ASIC), and/or a suitable processing unit.

In one or more embodiments, computer-readable storage medium 404 is an electronic, magnetic, optical, electromagnetic, infrared, and/or a semiconductor system (or apparatus or device). For example, computer-readable storage medium 404 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 404 includes a compact disk-read only memory (CD-ROM), a compact disk-read/write (CD-R/W), and/or a digital video disc (DVD).

In one or more embodiments, storage medium 404 stores computer program code 406 configured to cause processor-based system 400 to be usable for performing a portion or all the noted processes and/or methods. In one or more embodiments, storage medium 404 further stores information, such as an algorithm which facilitates performing a portion or all the noted processes and/or methods.

Processor-based system 400 includes I/O interface 410. I/O interface 410 is coupled to external circuitry. In one or more embodiments, I/O interface 410 includes a keyboard, keypad, mouse, trackball, trackpad, touchscreen, and/or cursor direction keys for communicating information and commands to processor 402.

Processor-based system 400 further includes network interface 412 coupled to processor 402. Network interface 412 allows processor-based system 400 to communicate with network 414, to which one or more other computer systems are connected. Network interface 412 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, are implemented in two or more processors 402.

Processor-based system 400 is configured to receive information through I/O interface 410. The information received through I/O interface 410 includes one or more of instructions, data, rules, and/or other parameters for processing by processor 402. The information is transferred to processor 402 via bus 408. Processor-based system 400 is configured to receive information related to user-interface (UI) 422 through I/O interface 410. The information is stored in computer-readable medium 404 as user interface (UI) 422.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application. [1] An aspect of this description relates to a method. The method includes receiving a list of radio nodes, wherein each of the radio nodes is usable in a wireless network, and each of the radio nodes has a corresponding coverage area. The method further includes selecting, by a processor, a first radio node from the list of radio nodes. The method further includes creating, by the processor, a first batch in which one or more radio nodes are to be assigned. The method further includes assigning, by the processor, the first radio node to the first batch. The method further includes selecting, by the processor, a second radio node from the list of radio nodes. The method further includes determining, by the processor, whether the corresponding coverage area of the second radio node overlaps with the corresponding coverage area of the first radio node. The method further includes assigning, by the processor, the second radio node to the first batch in response to a determination that the corresponding coverage area of the second radio node does not overlap with the corresponding coverage area of the first radio node.

[2] The method of [1], further comprising in response to a determination that the corresponding coverage area of the second radio node overlaps with the corresponding coverage area of the first radio node: creating, by the processor, a second batch different from the first batch; and assigning, by the processor, the second radio node to the second batch.

[3] The method of [1] or [2], further comprising determining, by the processor, whether any radio nodes in the list of radio nodes is unassigned to a created batch; in response to there being at least one unassigned radio node, selecting, by the processor, a next radio node from the list of radio nodes; and determining, by the processor, a smallest batch among the created batches, wherein the smallest batch is a batch of the create batches having a fewest number of assigned nodes.

[4] The method of any of [1] to [3], further comprising determining, by the processor, whether the next radio node is compatible with the smallest batch; and assigning, by the processor, the next radio node to the smallest batch in response to a determination that the next node is compatible with the smallest batch.

[5] The method any of [1] to [4], wherein determining, by the processor, whether the next radio node is compatible with the smallest batch comprises determining that the next radio node is compatible with the smallest batch in response to the corresponding coverage area of the next radio node failing to overlap with the corresponding coverage area of any other radio node in the smallest batch.

[6] The method of any of [1] to [5], wherein determining, by the processor, whether the next radio node is compatible with the smallest batch comprises determining the next radio node is compatible with the smallest batch in response to a determination that the next radio node is currently unassigned to any of the created batches.

[7] The method of any of [1] to [6], wherein determining, by the processor, whether the next radio node is compatible with the smallest batch comprises determining the next radio node is compatible with the smallest batch in response to a determination that (i) the corresponding coverage area of the next radio node overlaps with the corresponding coverage area of at least one radio node assigned to the smallest batch, and (ii) the next radio node is safe from causing a violation of a compensator repetition count.

[8] The method of any of [1] to [7], wherein determining, by the processor, whether the next radio node is compatible with the smallest batch comprises determining the next radio node is compatible with the smallest batch in response to a determination that a compensator repeat priority for the next radio node is below a predetermined threshold.

[9] An aspect of this description relates to an apparatus. The apparatus includes a processor configured to access computer-readable instructions. The processor is configured to execute the computer-readable instructions to cause the apparatus for receiving a list of radio nodes, wherein each of the radio nodes is usable in a wireless network, and each of the radio nodes has a corresponding coverage area. The processor is configured to execute the computer-readable instructions to cause the apparatus for selecting a first radio node from the list of radio nodes. The processor is configured to execute the computer-readable instructions to cause the apparatus for creating a first batch in which one or more radio nodes are to be assigned. The processor is configured to execute the computer-readable instructions to cause the apparatus for assigning the first radio node to the first batch. The processor is configured to execute the computer-readable instructions to cause the apparatus for selecting a second radio node from the list of radio nodes. The processor is configured to execute the computer-readable instructions to cause the apparatus for determining whether the corresponding coverage area of the second radio node overlaps with the corresponding coverage area of the first radio node. The processor is configured to execute the computer-readable instructions to cause the apparatus for assigning the second radio node to the first batch in response to a determination that the corresponding coverage area of the second radio node does not overlap with the corresponding coverage area of the first radio node.

[10] The apparatus of [9], wherein the processor is configured to execute the computer-readable instructions to cause the apparatus for in response to a determination that the corresponding coverage area of the second radio node overlaps with the corresponding coverage area of the first radio node: creating a second batch different from the first batch; and
assigning the second radio node to the second batch.

[11] The apparatus of [9] or [10], wherein the processor is configured to execute the computer-readable instructions to cause the apparatus for determining whether any radio nodes in the list of radio nodes is unassigned to a created batch; in response to there being at least one unassigned radio node, selecting a next radio node from the list of radio nodes; and determining a smallest batch among the created batches, wherein the smallest batch is a batch of the create batches having a fewest number of assigned nodes.

[12] The apparatus of any of [9] to [11], wherein the processor is configured to execute the computer-readable instructions to cause the apparatus for determining whether the next radio node is compatible with the smallest batch; and assigning the next radio node to the smallest batch in response to a determination that the next node is compatible with the smallest batch.

[13] The apparatus of any of [9] to [12], wherein the processor is configured to execute the computer-readable instructions to cause the apparatus for determining that the next radio node is compatible with the smallest batch in response to the corresponding coverage area of the next radio node failing to overlap with the corresponding coverage area of any other radio node in the smallest batch.

[14] The apparatus of any of [9] to [13], wherein the processor is configured to execute the computer-readable instructions to cause the apparatus for determining that the next radio node is compatible with the smallest batch in response to a determination that the next radio node is currently unassigned to any of the created batches.

[15] The apparatus of any of [9] to [14], wherein the processor is configured to execute the computer-readable instructions to cause the apparatus for determining that the next radio node is compatible with the smallest batch in response to a determination that (i) the corresponding coverage area of the next radio node overlaps with the corresponding coverage area of at least one radio node assigned to the smallest batch, and (ii) the next radio node is safe from causing a violation of a compensator repetition count.

[16] The apparatus of any of [9] to [15], wherein the processor is configured to execute the computer-readable instructions to cause the apparatus for determining that the next radio node is compatible with the smallest batch in response to a determination that a compensator repeat priority for the next radio node is below a predetermined threshold.

[17] An aspect of this description relates to a non-transitory computer-readable media having computer-readable instructions stored thereon. The computer-readable instructions when executed by a processor causes an apparatus to receive a list of radio nodes, wherein each of the radio nodes is usable in a wireless network, and each of the radio nodes has a corresponding coverage area. The computer-readable instructions when executed by a processor causes an apparatus to select a first radio node from the list of radio nodes. The computer-readable instructions when executed by a processor causes an apparatus to create a first batch in which one or more radio nodes are to be assigned. The computer-readable instructions when executed by a processor causes an apparatus to assign the first radio node to the first batch. The computer-readable instructions when executed by a processor causes an apparatus to select a second radio node from the list of radio nodes. The computer-readable instructions when executed by a processor causes an apparatus to determine whether the corresponding coverage area of the second radio node overlaps with the corresponding coverage area of the first radio node. The computer-readable instructions when executed by a processor causes an apparatus to assign the second radio node to the first batch in response to a determination that the corresponding coverage area of the second radio node does not overlap with the corresponding coverage area of the first radio node.

[18] The non-transitory computer-readable media of [17], wherein the computer-readable instructions further cause the apparatus to in response to a determination that the corresponding coverage area of the second radio node overlaps with the corresponding coverage area of the first radio node create a second batch different from the first batch; and assign the second radio node to the second batch.

[19] The non-transitory computer-readable media of or [18], wherein the computer-readable instructions further cause the apparatus to determine whether any radio nodes in the list of radio nodes is unassigned to a created batch; in response to there being at least one unassigned radio node, select a next radio node from the list of radio nodes; and determine a smallest batch among the created batches, wherein the smallest batch is a batch of the create batches having a fewest number of assigned nodes.

[20] The non-transitory computer-readable media of any of to [19], wherein the computer-readable instructions further cause the apparatus to determine whether the next radio node is compatible with the smallest batch; and assign the next radio node to the smallest batch in response to a determination that the next node is compatible with the smallest batch.

Separate instances of these programs can be executed on or distributed across any number of separate computer systems. Thus, although certain operations have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

The foregoing disclosure provides illustration and description but is not intended to be exhaustive or to limit the implementations to the precise form disclosed. Modifications and variations are possible in light of the above disclosure or may be acquired from practice of the implementations.

What is claimed is:

1. A method, comprising:
receiving a list of radio nodes, wherein each of the radio nodes is usable in a wireless network, and each of the radio nodes has a corresponding coverage area;
selecting, by a processor, a first radio node from the list of radio nodes;
creating, by the processor, a first batch in which one or more radio nodes are to be assigned;
assigning, by the processor, the first radio node to the first batch;
selecting, by the processor, a second radio node from the list of radio nodes;
determining, by the processor, whether the corresponding coverage area of the second radio node overlaps with the corresponding coverage area of the first radio node; and
assigning, by the processor, the second radio node to the first batch in response to a determination that the corresponding coverage area of the second radio node does not overlap with the corresponding coverage area of the first radio node.

2. The method of claim 1, further comprising:
in response to a determination that the corresponding coverage area of the second radio node overlaps with the corresponding coverage area of the first radio node:
creating, by the processor, a second batch different from the first batch; and
assigning, by the processor, the second radio node to the second batch.

3. The method of claim 2, further comprising:
determining, by the processor, whether any radio nodes in the list of radio nodes is unassigned to a created batch;
in response to there being at least one unassigned radio node, selecting, by the processor, a next radio node from the list of radio nodes; and
determining, by the processor, a smallest batch among the created batches, wherein the smallest batch is a batch of the create batches having a fewest number of assigned nodes.

4. The method of claim 3, further comprising:
determining, by the processor, whether the next radio node is compatible with the smallest batch; and
assigning, by the processor, the next radio node to the smallest batch in response to a determination that the next node is compatible with the smallest batch.

5. The method of claim 4, wherein
determining, by the processor, whether the next radio node is compatible with the smallest batch comprises determining that the next radio node is compatible with the smallest batch in response to
the corresponding coverage area of the next radio node failing to overlap with the corresponding coverage area of any other radio node in the smallest batch.

6. The method of claim 4, wherein determining, by the processor, whether the next radio node is compatible with the smallest batch comprises determining the next radio node is compatible with the smallest batch in response to a determination that the next radio node is currently unassigned to any of the created batches.

7. The method of claim 4, wherein determining, by the processor, whether the next radio node is compatible with the smallest batch comprises determining the next radio node is compatible with the smallest batch in response to a determination that (i) the corresponding coverage area of the next radio node overlaps with the corresponding coverage area of at least one radio node assigned to the smallest batch, and (ii) the next radio node is safe from causing a violation of a compensator repetition count.

8. The method of claim 4, wherein determining, by the processor, whether the next radio node is compatible with the smallest batch comprises determining the next radio node is compatible with the smallest batch in response to a determination that a compensator repeat priority for the next radio node is below a predetermined threshold.

9. An apparatus, comprises:
a processor configured to access computer-readable instructions, wherein the processor is configured to execute the computer-readable instructions to cause the apparatus for:
receiving a list of radio nodes, wherein each of the radio nodes is usable in a wireless network, and each of the radio nodes has a corresponding coverage area;
selecting a first radio node from the list of radio nodes;
creating a first batch in which one or more radio nodes are to be assigned;
assigning the first radio node to the first batch;
selecting a second radio node from the list of radio nodes;
determining whether the corresponding coverage area of the second radio node overlaps with the corresponding coverage area of the first radio node; and
assigning the second radio node to the first batch in response to a determination that the corresponding coverage area of the second radio node does not overlap with the corresponding coverage area of the first radio node.

10. The apparatus of claim 9, wherein the processor is configured to execute the computer-readable instructions to cause the apparatus for:
in response to a determination that the corresponding coverage area of the second radio node overlaps with the corresponding coverage area of the first radio node:
creating a second batch different from the first batch; and
assigning the second radio node to the second batch.

11. The apparatus of claim 10, wherein the processor is configured to execute the computer-readable instructions to cause the apparatus for:
determining whether any radio nodes in the list of radio nodes is unassigned to a created batch;
in response to there being at least one unassigned radio node, selecting a next radio node from the list of radio nodes; and
determining a smallest batch among the created batches, wherein the smallest batch is a batch of the create batches having a fewest number of assigned nodes.

12. The apparatus of claim 11, wherein the processor is configured to execute the computer-readable instructions to cause the apparatus for:
determining whether the next radio node is compatible with the smallest batch; and
assigning the next radio node to the smallest batch in response to a determination that the next node is compatible with the smallest batch.

13. The apparatus of claim 12, wherein the processor is configured to execute the computer-readable instructions to cause the apparatus for:
determining that the next radio node is compatible with the smallest batch in response to the corresponding coverage area of the next radio node failing to overlap with the corresponding coverage area of any other radio node in the smallest batch

14. The apparatus of claim 12, wherein the processor is configured to execute the computer-readable instructions to cause the apparatus for:
determining that the next radio node is compatible with the smallest batch in response to a determination that the next radio node is currently unassigned to any of the created batches.

15. The apparatus of claim 12, wherein the processor is configured to execute the computer-readable instructions to cause the apparatus for:
determining that the next radio node is compatible with the smallest batch in response to a determination that (i) the corresponding coverage area of the next radio node overlaps with the corresponding coverage area of at least one radio node assigned to the smallest batch, and (ii) the next radio node is safe from causing a violation of a compensator repetition count.

16. The apparatus of claim 12, wherein the processor is configured to execute the computer-readable instructions to cause the apparatus for:
determining that the next radio node is compatible with the smallest batch in response to a determination that a compensator repeat priority for the next radio node is below a predetermined threshold.

17. A non-transitory computer-readable media having computer-readable instructions stored thereon, which when executed by a processor causes an apparatus to:
receive a list of radio nodes, wherein each of the radio nodes is usable in a wireless network, and each of the radio nodes has a corresponding coverage area;
select a first radio node from the list of radio nodes;
create a first batch in which one or more radio nodes are to be assigned;
assign the first radio node to the first batch;
select a second radio node from the list of radio nodes;
determine whether the corresponding coverage area of the second radio node overlaps with the corresponding coverage area of the first radio node; and
assign the second radio node to the first batch in response to a determination that the corresponding coverage area of the second radio node does not overlap with the corresponding coverage area of the first radio node.

18. The non-transitory computer-readable media of claim 17, wherein the computer-readable instructions further cause the apparatus to:
in response to a determination that the corresponding coverage area of the second radio node overlaps with the corresponding coverage area of the first radio node:
create a second batch different from the first batch; and
assign the second radio node to the second batch.

19. The non-transitory computer-readable media of claim 18, wherein the computer-readable instructions further cause the apparatus to:
determine whether any radio nodes in the list of radio nodes is unassigned to a created batch;
in response to there being at least one unassigned radio node, select a next radio node from the list of radio nodes; and
determine a smallest batch among the created batches, wherein the smallest batch is a batch of the create batches having a fewest number of assigned nodes.

20. The non-transitory computer-readable media of claim 19, wherein the computer-readable instructions further cause the apparatus to:
determine whether the next radio node is compatible with the smallest batch; and
assign the next radio node to the smallest batch in response to a determination that the next node is compatible with the smallest batch.
